(19) United States
(12) Patent Application Publication
(10) Pub. No.: US 2026/0369273 A1
(43) Pub. Date: Nov. 19, 2026

(54) IN-EAR SILENT-SPEECH DETECTION SYSTEM

(71) Applicant: OpenAI OpCo, LLC, San Francisco, CA (US)

(72) Inventors: Douglas Stuart Brodie, San Jose, CA (US); Daniel Boothe, San Francisco, CA (US)

(21) Appl. No.: 19/677,432

(22) Filed: May 14, 2026

Related U.S. Application Data
(60) Provisional application No. 63/805,864, filed on May 14, 2025.

(51) Int. Cl. G10L 15/24; G01B 7/28; G10L 15/26; G10L 15/30; H04R 1/08

(52) U.S. Cl. CPC G10L 15/24; G01B 7/28; G10L 15/26; G10L 15/30; H04R 1/083

(57) ABSTRACT

A wearable nonvocalized speech detection system may include a body configured to be positioned at least partially in an ear canal of a user, a sensing system positioned in the body and configured to detect motion of the ear canal resulting from articulation of a mouth of the user corresponding to a nonvocalized expression of one or more words and generate motion information representative of the detected motion, and a processing system operatively coupled to the sensing system and configured to generate, based on the motion information, a representation of the one or more words.

### CROSS REFERENCE TO RELATED APPLICATION(S)

This application is a nonprovisional patent application of and claims the benefit under 35 U.S.C. § 119(e) of U.S. Provisional Patent Application No. 63/805,864, filed May 14, 2025, and titled “In-Ear Silent-Speech Detection System,” the contents of which are incorporated herein by reference in its entirety.

### FIELD

The described embodiments relate generally to silent-speech detection systems. More particularly, the present embodiments relate to a wearable, in-ear sensing system that detects non-vocalized expressions of words based on ear-canal movements resulting from articulations of a user’s mouth.

### BACKGROUND

Electronic devices often receive and/or sense inputs from users. In some cases, inputs may be vocalized inputs, such as a user audibly speaking words. Vocalized inputs may be used to control electronic devices, communicate with others (e.g., via two-way radio communications), generate text representations of spoken words, and the like.

### SUMMARY

A wearable nonvocalized speech detection system may include a body configured to be positioned at least partially in an ear canal of a user, a sensing system positioned in the body and configured to detect motion of the ear canal resulting from articulation of a mouth of the user corresponding to a nonvocalized expression of one or more words and generate motion information representative of the detected motion, and a processing system operatively coupled to the sensing system and configured to generate, based on the motion information, a representation of the one or more words. The sensing system may include an accelerometer. The sensing system may include an inertial measurement unit.

The wearable nonvocalized speech detection system may further include a compliant structure coupled to the body and configured to contact a surface of the ear canal, the sensing system may further include a sensing element coupled to the compliant structure, the sensing system may be further configured to detect, via the sensing element, a change in shape of the surface of the ear canal resulting from the articulation of the user’s mouth corresponding to the nonvocalized expression of the one or more words and generate deformation information representative of the detected change in shape of the surface of the ear canal, and the processing system may be further configured to generate the representation of the one or more words further based on the deformation information. The sensing element may include a strain gauge. The motion of the ear canal may occur as a result of movement of a temporomandibular joint during the nonvocalized expression of the one or more words.

The wearable nonvocalized speech detection system may further include a wireless communication system operatively coupled to the processing system and configured to send the representation of the one or more words to a remote device. The remote device may be configured to generate an audio output of the one or more words in response to receiving the representation of the one or more words.

The processing system may be configured to execute a machine learning model to generate the representation of the one or more words, the machine learning model trained on training data including sample motion information generated by the sensing system in response to nonvocalized expressions by the user of a set of training words.

A wearable nonvocalized speech detection system may include a body configured to be positioned at least partially in an ear canal of a user, a compliant structure coupled to the body and configured to contact a surface of the ear canal, a sensing system including a sensing element coupled to the compliant structure, the sensing system configured to detect, via the sensing element, a change in shape of the surface of the ear canal resulting from articulation of a mouth of the user corresponding to a nonvocalized expression of one or more words and generate deformation information representative of the detected change in shape of the surface of the ear canal, and a processing system operatively coupled to the sensing system and configured to generate, based on the deformation information, a representation of the one or more words.

The sensing element may be a strain gauge. The sensing element may be at least partially embedded in the compliant structure. The compliant structure may include a flexible polymer.

The sensing system may further include a motion sensing system, the sensing system may be further configured to detect, via the motion sensing system, motion of the ear canal resulting from the articulation of the user’s mouth corresponding to the nonvocalized expression of the one or more words and generate motion information representative of the detected motion, and the processing system may be further configured to generate the representation of the one or more words further based on the motion information. The change in shape of the surface of the ear canal may occur as a result of movement of a temporomandibular joint during the nonvocalized expression of the one or more words.

The processing system may be configured to execute a machine learning model to generate the representation of the one or more words, the machine learning model trained on training data including sample deformation information generated by the sensing system in response to nonvocalized expressions by the user of a set of training words.

The wearable nonvocalized speech detection system may further include a wireless communication system operatively coupled to the processing system and configured to send the representation of the one or more words to a remote device.

The wearable nonvocalized speech detection system may further include a microphone configured to detect vibrations resulting from phonated speech. The microphone may be a bone conduction microphone. The phonated speech may be below about 30 dB.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example ear-worn sensing device;

FIGS. 2A-2B show another example ear-worn sensing device;

FIGS. 3A-3B show a portion of an ear-worn sensing device undergoing deformation due to deformation of an ear canal surface;

FIG. 4 shows an example system diagram of a wearable nonvocalized speech detection system;

FIG. 5 shows an example technique for generating a representation of words from nonvocalized speech; and

FIG. 6 is a system diagram of the components of an example emotive companion.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Described herein are ear-worn sensing devices that can determine words that are “silently” spoken by a person, such as when the person pantomimes or “mouths” words without vocalizing them. In particular, the ear-worn sensing devices may leverage biomechanical sensing systems to detect speech-related jaw movement, specifically via the temporomandibular joint (TMJ). The biomechanical sensing systems are positioned at least partially in the ear canal to detect TMJ motion during nonvocalized expressions of words. By capturing fine movements of the jaw, the ear-worn sensing devices can determine phonemic and articulatory intent (e.g., the nonvocalized words), even in the absence of sound.

The words that are detected may be used for various purposes. For example, the words may be used as a command to an electronic device, or they may be communicated to another electronic device or user, or they may be saved and/or displayed as text for later reference. Thus, the ear-worn sensing systems allow users to interact with electronic devices silently. This technique may be more efficient and/or desirable for various purposes. For example, a user can interact with an electronic device without having to physically manipulate the device (e.g., to type inputs or interact with buttons, etc.). Moreover, since the ear-worn sensing devices detect even silent speech events, users can interact with devices in many circumstances, including those where vocalizing words would not be appropriate or desirable.

As used herein, a nonvocalized expression of words (also referred to simply as nonvocalized speech) occurs when a person produces biomechanical movement of one or more muscles, joints, or other anatomical structures of their face, including the temporomandibular joint. For example, a user may “mouth” or “pantomime” the speaking of words, without vocalizing the words. This may result in biomechanical motion without sound, or with low sound output (e.g., below a whisper level). Nonvocalized expressions of words may be inaudible to other listeners, but need not be completely silent or completely inaudible. For example, sounds may be produced during nonvocalized expressions, though such sounds may not be auditorily recognizable as spoken words, or may have low loudness (e.g., low volume, such as a whisper). More generally, the sensing systems described herein may be capable of determining nonvocalized expressions of speech (e.g., as they do not rely exclusively on audible sound to determine the intended words), but are not limited to detecting entirely silent expressions of words. In some cases, nonvocalized expression of words does not require a full pantomime or mouthing of words. For example, in some cases of subvocalization or silent speech, miniscule movements of a person’s anatomy may occur while the person is thinking about or reading words (even if those movements are not visibly perceptible to observers or even perceptible to the person). In some cases, the ear-worn sensing devices described herein may detect nonvocalized expressions using such miniscule and/or unconscious movements and/or biomechanical responses. As used herein, “silent speech” or “silently” speaking, or variants thereof, encompass the various examples of nonvocal or subvocal speech (or expressions) given herein.

The devices described herein may include sensing systems, processing systems, and communication systems. The sensing systems may facilitate the detection of phenomena associated with nonvocalized expressions of words. For example, the sensing systems may include motion sensors, vibration sensors, deformation (e.g., strain-based) sensors, pressure sensors (e.g., air pressure sensors, barometric sensors, ambient pressure sensors, etc.), microphones (which may detect sound or pressure waves associated with or resulting from nonvocalized expressions), or the like. These sensing systems may detect motion, deformation, vibration, air pressure, changes in anatomical volume (e.g., space inside the ear), or other biomechanical phenomena in the ear canal of a wearer, resulting from nonvocalized expressions of words. The devices may include processing systems that interoperate with the sensing systems to generate representations of the words based on the sensed biomechanical information. The representations of the words may be used for various purposes, such as to control an electronic device, generate communication messages, generate text content, etc.

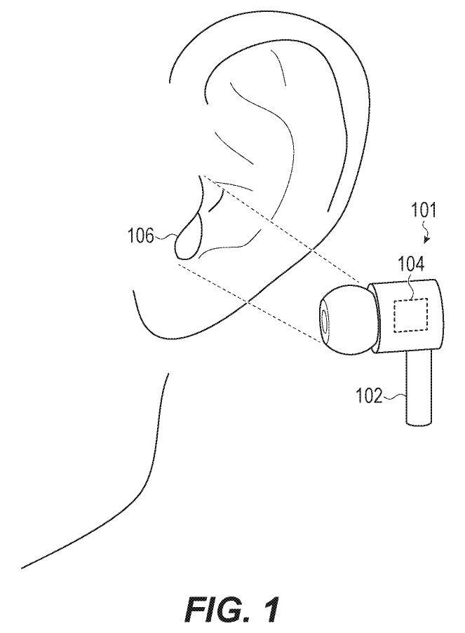

FIG. 1 depicts an example ear-worn sensing device 101. The ear-worn sensing device 101 is an example of a wearable nonvocalized speech detection system (or a portion of such a system) that detects nonvocalized speech. The ear-worn sensing device 101 includes a body 102 configured to be positioned at least partially in an ear canal 106 of a user. The body 102 may have various forms and/or shapes. At least a portion of the body 102 may have a shape that generally matches or is complementary to a shape of an ear canal of a user. In some cases, the body 102 may be or may resemble an earbud, an in-ear monitor, ear plug, or other ear-worn device. In some cases, all or a portion of the body may be customized to match a particular user’s ear canal (e.g., by creating the body portion from a mold of a user’s ear canal).

The ear-worn sensing device 101 may include compliant structures that at least partially conform to the surface of a user’s ear canal. Such compliant structures may include, for example, flexible polymer tips or gaskets that are coupled to (or are part of) the body 102. The compliant structures may cause an intimate contact between a portion of the ear-worn sensing device 101 and a surface of the user’s ear canal, such that movement of the surface of the ear canal results in a corresponding movement of the portion of the ear-worn sensing device 101. The compliant structures (and the intimate contact with the surface of the ear canal) may also act as a seal that defines an at least partially air-sealed cavity in the user’s ear canal. As described herein, a pressure sensing system of the ear-worn sensing device 101 may detect changes in pressure within this cavity.

The ear-worn sensing device 101 may include a sensing system 104. The sensing system 104 may be positioned at least partially in the body 102 and may be configured to detect one or more biomechanical (or other) phenomena associated with nonvocalized speech events (including speech events having a volume less than about 30 dB, less than about 20 dB, less than about 10 dB, or lower). For example, the sensing system 104 may be configured to detect motion of the ear canal resulting from articulation of the user’s mouth corresponding to a nonvocalized expression of one or more words, and generate motion information representative of the detected motion. Such motion may be due to movement of the temporomandibular joint, and/or muscles or other anatomical structures that can result in motion of the ear canal or objects therein. In some cases, the sensing system 104 is configured to detect changes in air pressure (and/or sound or other pressure waves or disturbances) within the user’s ear canal resulting from articulation of the user’s mouth corresponding to a nonvocalized expression of one or more words.

To sense the motion of the ear canal (or, more particularly, motion imparted to the ear-worn sensing device 101 via the ear canal), the sensing system 104 may include motion sensing components and associated systems. For example, the sensing system 104 may include an inertial measurement unit, an accelerometer, a gyroscope, a magnetometer, and/or various combinations of these (and/or other) components. The sensing system 104 may include various components to facilitate the sensing operations, including, without limitation, microelectromechanical sensing elements, processors, electrical circuitry, software, firmware, and the like. In some cases, the sensing system 104 includes a 3-axis accelerometer and a 3-axis gyroscope. The sensing system 104 may be oriented, within the body 102, to advantageously detect movements via the ear canal. The sensing system 104 may operate at a configurable sample rate, which may range between about 100 Hz to about 1000 Hz. Other sample rates are also contemplated. The sensing system 104 may detect various motion (or motion-related) parameters of the ear-worn sensing device 101, such as translation, rotation, acceleration, velocity, orientation, and the like.

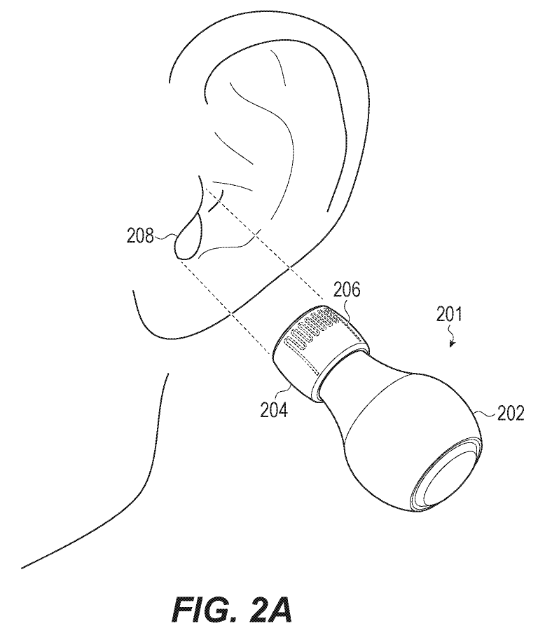

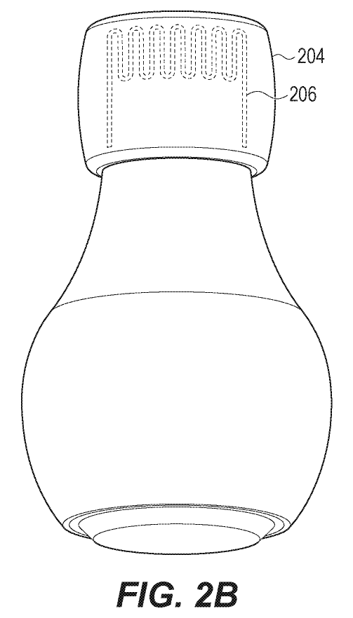

In some cases, the sensing system 104 includes additional or different sensors. For example, instead of or in addition to the motion sensing components, the sensing system 104 may include a deformation sensor that is configured to detect changes to the shape of the surface of the ear canal resulting from nonvocalized speech (e.g., from the articulation of the user’s mouth during nonvocalized expression of words). These changes in the shape may also result in device motion (e.g., translation, rotation, acceleration, etc., which may be detected by the motion sensing components), but the deformation sensor may detect the changes in shape more directly (and optionally without reference to or reliance on the resulting motion of the ear-worn sensing device). The deformation sensor may be coupled to a compliant structure that contacts and/or conforms to a surface of the ear canal, and that detects changes to the shape of the ear canal surface resulting from nonvocalized speech. The deformation sensor may include a sensing element that produces a signal in response to deformations or strain, including but not limited to strain gauges, piezoelectric and/or piezoresistive elements, capacitive elements, or the like. FIGS. 2A-2B illustrate another example ear-worn sensing device that includes a deformation sensing system, and the discussion of that deformation sensing system applies equally to the ear-worn sensing device 101.

As another example, the sensing system 104 may include a bone conduction or contact microphone, which may detect vibrations resulting from jaw movement (and optionally other phenomena, such as tongue movement, air passing through the vocal tract, phonated speech, fine vibrations resulting from the nonvocalized or subvocalized speech, or the like). Such components may be coupled to the body 102 such that they are in contact with a surface of the ear canal when the ear-worn sensing device 101 is being worn.

As another example, the sensing system 104 may include a pressure sensing system that detects changes in pressure within the user’s ear canal. Changes in pressure may occur, for example, due to changes in an interior volume or shape of the user’s ear canal (and/or the sealed volume defined by the ear-worn sensing device) when a user moves their mouth, tongue, or other anatomical feature during nonvocalized speech. The pressure sensing system may use any suitable technology or technique for detecting pressure, including but not limited to piezo-based sensors (e.g., piezoelectric, piezoresistive), strain-based pressure sensors, microelectromechanical pressure sensors, and capacitive pressure sensors. In some cases, microphones may detect changes in pressure, which may manifest as sound or other acoustic phenomenon that is detectable by a microphone. The sensing system 104 may also include microphones for detecting sound.

In some cases, multiple sensing subsystems (e.g., motion, deformation or surface shape, vibration, pressure, sound) are used together in a wearable nonvocalized speech detection system, to provide a multi-modal sensing system. For example, the ear-worn sensing device 101 may use sensor fusion techniques to jointly process and/or analyze the information from multiple sensing systems. In some cases, the information from the sensing systems may be provided to one or more models (e.g., machine learning models, generative output engines, etc.), which may use the information to generate a representation of words that were nonvocally expressed by a user. Using information from multiple sensing systems (including information that represents or reflects different biomechanical phenomena and/or results of biomechanical phenomena) may improve the performance of the system, as the different sensing subsystems may provide different information about the biomechanical responses to nonvocalized speech, and the joint analysis of that information may provide more comprehensive and/or accurate results. In some cases, sensing subsystems may serve to disambiguate events detected by other sensing subsystems.

While FIG. 1 illustrates a single ear-worn device, a wearable nonvocalized speech detection system may include multiple ear-worn sensing devices (e.g., a pair of earbuds). In such cases, the devices may have the same or essentially the same components and/or systems (e.g., sensing systems, processing systems, communication systems), or they may have different components and/or systems. For example, one ear-worn sensing device of a pair may include a sensing system 104, while the other may not include a sensing system 104. Or one device may include a first type of sensing subsystem (e.g., for motion-based sensing), while the other includes a second type of sensing subsystem (e.g., for deformation- or shape-based sensing).

In some cases, the wearable nonvocalized speech detection system may include audio input and output systems to provide conventional earbud functionality. For example, the wearable nonvocalized speech detection system may include one or more speakers configured to output sound, such as music, voice communications, audiobooks, or the like (e.g., from a wired or wirelessly coupled device). The wearable nonvocalized speech detection system may also include one or more microphones configured to capture sound external to the user’s ear canal, such as for voice communications, voice commands, speech-to-text, or the like.

FIGS. 2A-2B depict another example ear-worn sensing device 201. The ear-worn sensing device 201 is an example of a wearable nonvocalized speech detection system (or a component of a wearable nonvocalized speech detection system) that detects nonvocalized speech. The ear-worn sensing device 201 includes a body 202 configured to be positioned at least partially in an ear canal 208 of a user. The body 202 may have various forms and/or shapes. At least a portion of the body 202 may have a shape that generally matches or is complementary to a shape of an ear canal of a user. In some cases, the body 202 may be or may resemble an earbud, an in-ear monitor, ear plug, or other ear-worn device. In some cases, all or a portion of the body may be customized to match a particular user’s ear canal (e.g., by creating the body portion from a mold of a user’s ear canal).

The ear-worn sensing device 201 includes a compliant structure 204 that at least partially conforms to the surface of a user’s ear canal. The compliant structure 204 may be formed from a flexible polymer material (e.g., silicone, thermoplastic polyurethane, polymer foam, etc.). The compliant structure 204 may be configured to deform or otherwise conform to the shape of the user’s ear canal when the compliant structure 204 is inserted into the ear canal, such that the surface of the compliant structure 204 is biased into contact with the surface of the ear canal.

The ear-worn sensing device 201 may include a sensing system, which includes a deformation sensing element 206 coupled to the compliant structure 204 (also shown in FIG. 2B). The deformation sensing element 206 may be responsive to deformation or strain induced in the sensing element by deformation of the compliant structure 204, and may generate deformation information representative of the deformation. For example, since the compliant structure 204 is in contact with (and flexibly conforms to) the ear canal surface, change in shape of the ear canal surface (e.g., deformations) resulting from nonvocalized speech results in a deformation of the deformation sensing element 206. The deformation sensing element 206 may produce a signal or other output in response to deformation caused by the ear canal surface (deformation information), and an associated processing system may determine a representation of the nonvocalized words based on the deformation information from the deformation sensing element 206.

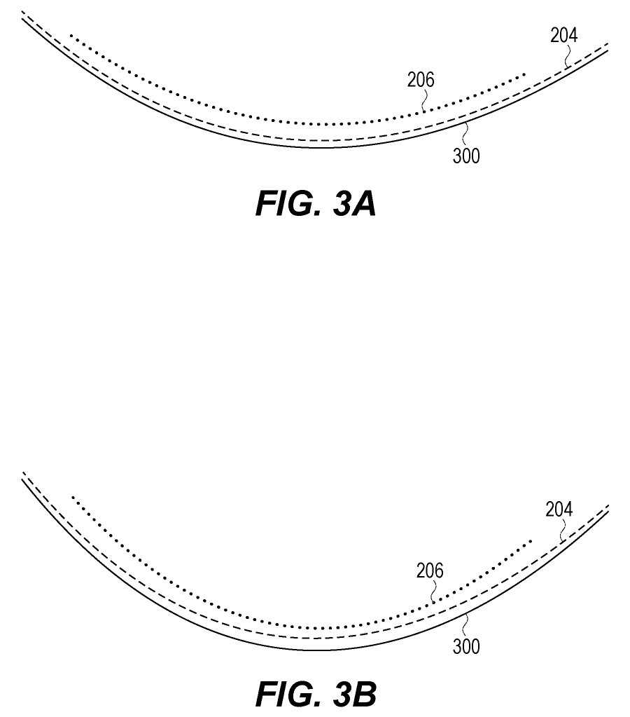

FIGS. 3A-3B depict a representation of the compliant structure 204 and the coupled deformation sensing element 206 deforming as a result of changes of the shape of the ear canal surface 300. More particularly, FIG. 3A illustrates the ear canal surface 300 in a first shape, and FIG. 3B illustrates the ear canal surface 300 in a different shape. The change in shape in FIGS. 3A-3B is exaggerated for the purposes of illustration. The transition from the first shape to the second shape may result from jaw movements during nonvocalized speech. Since the compliant structure 204 is conformable and biases against the ear canal surface 300, the change in the shape of the surface 300 causes deformation of the compliant structure 204 and, consequently, the deformation sensing element 206.

For ease of illustration, FIGS. 2A-3B illustrate one deformation sensing element coupled to the compliant structure. However, an ear-worn sensing device may include one or multiple deformation sensing elements (of the same or different type). For example, an ear-worn sensing device may include an array of deformation sensing elements arranged around a periphery of the compliant structure in order to capture deformation information at a plurality of points or locations around the ear canal.

The deformation sensing element 206 may be at least partially embedded in the compliant structure 204. For example, the deformation sensing element 206 may be insert molded with the compliant material of the compliant structure 204. In this way, deformation of the compliant structure 204 results in the deformation of the sensing element 206. In other cases, the deformation sensing element 206 is coupled to the compliant structure 204 in other ways, such as via adhesive, fasteners, ultrasonic welding, or the like.

The deformation sensing element 206 may be any type of sensing element that is responsive to deformations or strain. For example, the deformation sensing element 206 may be or may include (alone or in various combinations) a strain gauge, a piezoresistive element, a piezoelectric element, a quantum tunneling material, a capacitive displacement sensor, an optical sensor, or the like.

In some cases, the ear-worn sensing device 201 includes additional or different sensors, as described with respect to the ear-worn sensing device 101. For example, the ear-worn sensing device 201 may include a motion sensing system and/or a vibration sensing system. Such components may be used to provide a multi-modal sensing system for the ear-worn sensing device 201.

While FIG. 1 illustrates a single ear-worn device, a wearable nonvocalized speech detection system may include multiple ear-worn sensing devices (e.g., a pair of earbuds). In such cases, the devices may have the same or essentially the same components and/or systems (e.g., sensing systems, processing systems, communication systems), or they may have different components and/or systems. For example, one ear-worn sensing device of a pair may include a sensing system 104, while the other may not include a sensing system 104. Or one device may include a first type of sensing subsystem (e.g., for motion-based sensing), while the other includes a second type of sensing subsystem (e.g., for deformation- or shape-based sensing).

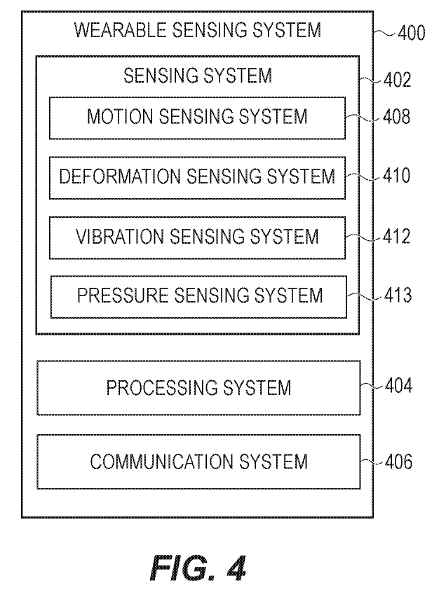

The ear-worn sensing devices 101, 201 described above may also include other systems or subsystems, such as a processing system and a communication system, as described with respect to FIG. 4.

FIG. 4 depicts a schematic view of a wearable nonvocalized speech detection system 400, which may represent one or multiple ear-worn sensing devices, as described herein (e.g., the ear-worn sensing devices 101, 201). The wearable nonvocalized speech detection system 400 includes a sensing system 402, a processing system 404, and a communication system 406. The wearable nonvocalized speech detection system 400 may include other systems as well, including audio output systems, audio input systems, touch, or other input systems (e.g., for receiving inputs to control the wearable nonvocalized speech detection system or a remote device in communication with the wearable nonvocalized speech detection system), haptic output systems, and the like.

The sensing system 402 may include one or more sensing subsystems (alone or in various combinations). For example, the sensing system 402 may include a motion sensing system 408, a deformation sensing system 410, a vibration sensing system 412, and/or a pressure sensing system 413. The motion sensing system 408 may be configured to detect motion imparted to the wearable nonvocalized speech detection system 400 as a result of nonvocalized speech events, as described herein. The motion sensing system 408 may include one or more inertial measurement units, accelerometers, gyroscopes, or other suitable components, as well as processing systems, circuitry, and other systems, which together generate motion information representative of detected motion of the wearable nonvocalized speech detection system 400.

The deformation sensing system 410 may be configured to detect changes to the shape of an ear canal surface with which the deformation sensing system 410 is in contact (e.g., deformations, deflections, etc.). The deformation sensing system 410 may include one or more sensing elements, such as (alone or in various combinations) a strain gauge, a piezoresistive element, a piezoelectric element, a quantum tunneling material, a capacitive displacement sensor, an optical sensor, or the like. The deformation sensing system 410 may also include processing systems, circuitry, and other systems, which together generate deformation information representative of detected shape changes of the surface of the ear canal.

The vibration sensing system 412 may include a bone conduction or contact microphone, which may detect vibrations resulting from jaw movement (and optionally other phenomena, such as tongue movement, air passing through the vocal tract, or any other vibrations resulting from the nonvocalized speech). The vibration sensing system 412 may also include processing systems, circuitry, and other systems, which together generate information representative of vibration detected via the surface of (or otherwise within) the ear canal.

The pressure sensing system 413 may include an air pressure sensor, which may detect changes in air pressure (and/or absolute air pressure), pressure waves, and/or other pressure-based or acoustic phenomena resulting from jaw movement, tongue movement, air passing through the vocal tract, sinuses, eustachian tubes, etc., resulting from nonvocalized speech. The pressure sensing system 413 may also include processing systems, circuitry, and other systems, which together generate information representative of pressure and/or pressure changes detected within or proximate the ear canal.

The sensing system 402 (including any particular combination of its sensing subsystems) may be operatively coupled to a processing system 404. The processing system 404 may be configured to generate, based on information from the sensing system 402 (and optionally using sensor fusion techniques), a representation of words that were nonvocally expressed by a user. More particularly, as described herein, the sensing system 402 generates information (e.g., motion, deflection, vibration, etc.) resulting from articulation of a user’s mouth during a nonvocalized expression of one or more words. The processing system 404 may process or otherwise use this information to generate a representation of the one or more words. The representation may be a textual representation of the words, or a set of phoneme-level units that may be used to reconstruct speech (e.g., to output an audible representation of the nonvocalized speech). Textual representations of the words may be used for various purposes, such as commands or other inputs to a device (e.g., a device communicably coupled to the wearable nonvocalized speech detection system 400, or to the wearable nonvocalized speech detection system 400 itself), to generate text content (e.g., documents, notes, text-based messages, etc.), to generate text for text-to-speech applications, or the like. In some cases, the wearable nonvocalized speech detection system 400 is configured for use as or with a communications device, and the representation of the words are used to convey the words to another individual, such as via a complementary wearable nonvocalized speech detection system being worn by that individual (or on another device, such as a two-way radio, a mobile phone (e.g., via text message or voice message), a computer, or the like).

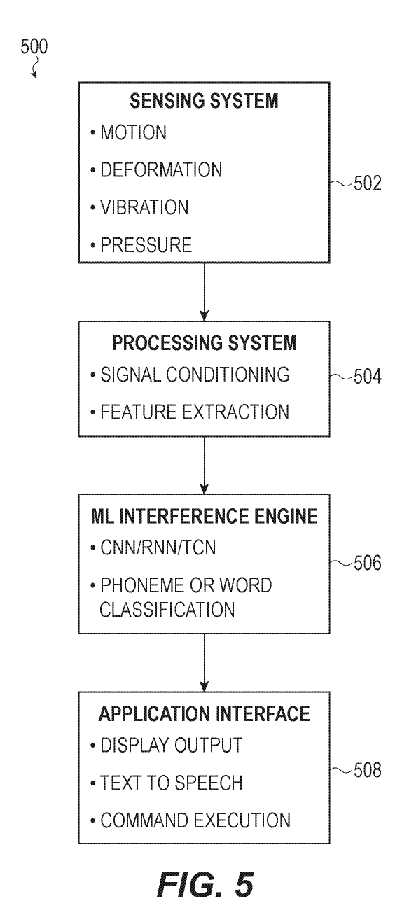

The wearable nonvocalized speech detection system 400 may also include a communication system 406. The communication system may be operatively coupled to the processing system 404 and/or the sensing system 402, and may be configured to communicate with one or more remote devices. The remote device may be configured to provide processing operations for generating the representation of the one or more words. For example, the wearable nonvocalized speech detection system 400 (e.g., with the processing system 404) may be configured to perform signal conditioning and feature extraction operations on the information from the sensing systems, and then send the extracted features (and/or other information) to the remote device, which may then process the received information to generate the representation of the words (e.g., using one or more machine learning models, engines, and/or other techniques, as described herein with respect to FIG. 5). The remote device may be a mobile phone, a computer, a dedicated processing device or base unit, a head mounted device (e.g., a head-mounted display), a virtual- or augmented-reality device, or the like. After further processing the received information to generate the representation of the words, the remote device may send the representation to yet another device (e.g., as a communication message, command, text-based input, or the like).

In some cases, the remote device does not perform processing operations to generate a representation of one or more words, but instead receives the representation of the words. For example, the remote device may be a communications device associated with another user, and the representation may be output to that user (e.g., as text, as an audible output, etc.). In this example, the wearable nonvocalized speech detection system 400 may be implemented as part of a communication system that allows individuals to communicate with one another using nonvocalized speech (optionally in addition to vocalized speech). For example, the wearable nonvocalized speech detection system 400 may be configured (with or without other tethered or coupled support devices) to communicate with other wearable nonvocalized speech detection systems 400. A representation of words that were silently spoken by a first user may be sent to a second user’s ear-worn sensing device to be output as a spoken output. A response from the second user, in the form of nonvocalized speech, may be received and processed by that user’s ear-worn sensing device and sent to the first user’s ear-worn sensing device to be output as a spoken output. Since the ear-worn sensing devices may provide audio outputs that are only audible to the wearer (as earbuds are generally largely silent to bystanders), a communication system using the wearable nonvocalized speech detection system described herein may facilitate largely silent communications. This may be useful to ensure communication privacy and allow communications in environments where speaking aloud would be impractical.

As another example, the remote device may be configured to accept commands and/or inputs from the wearable nonvocalized speech detection system, and may perform one or more operations in response to receiving the representation. Such remote devices may be any suitable device, including, without limitation, a mobile phone, a laptop or desktop computer, a tablet computer, an emotive companion, a robotic assistant, a television, an appliance, a home automation system or component, a lighting controller, or the like.

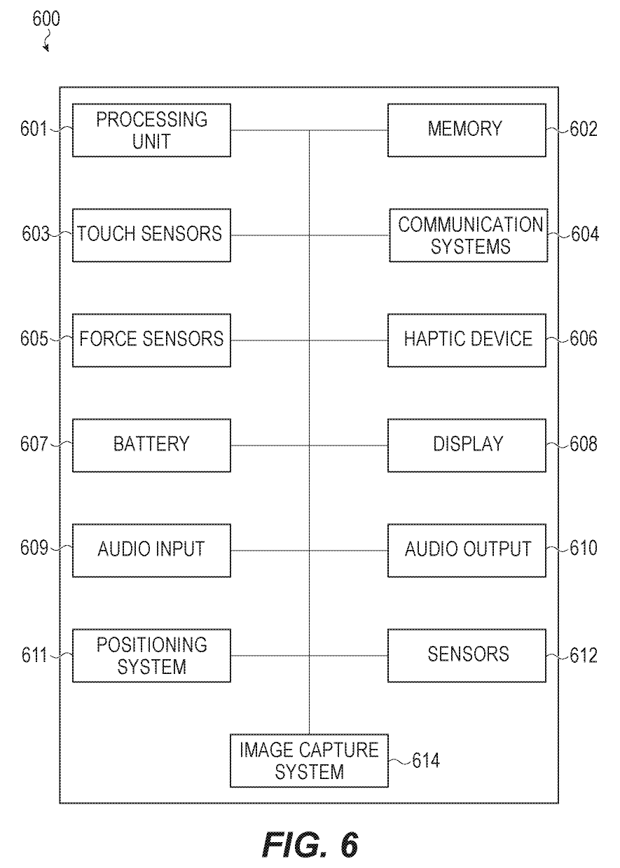

The communication system 406 may include various types of communications components for communicating in a variety of manners. In some cases, the communication system 406 facilitates communications via Bluetooth, cellular, WiFi, or other communications protocols, as described herein with respect to FIG. 6.

As described herein, the various components and systems of the wearable nonvocalized speech detection system may be distributed among various devices, including various ear-worn sensing devices and remote devices. For example, in some cases, processing and sensing systems may be distributed among two ear-worn sensing devices that are meant to be worn at the same time (e.g., one ear-worn sensing device includes a sensing system and a communication system, and the other includes a processing system and a communication system). Also as described herein, some processing operations for generating a representation of the nonvocalized words may be performed by one or more remote devices.

FIG. 5 depicts a signal processing pipeline 500 that may be leveraged by and/or implemented by a system as described herein operating in respect of an ear-worn sensing device. In some cases, the signal processing pipeline can be executed, in whole or in part, by an ear-worn sensing device as described herein. In other cases, an ear-worn sensing device can be operably coupled to one or more other processing devices that may cooperate with the ear-worn sensing device to perform one or more operations of the signal processing pipeline of FIG. 5. In yet other examples, an ear-worn sensing device as described herein can be configured to stream sensor information and/or data to a second (e.g., remote) electronic device that may be configured to receive the streamed information and/or data and perform operations of the signal processing pipeline FIG. 5. The streaming of data from the ear-worn sensing device may be wireless (e.g., via Bluetooth, Ultrawide Band, Wi-Fi, cellular, or the like) in some embodiments, although this is not required.

More broadly in view of the foregoing, it may be appreciated that the signal processing pipeline 500 may be performed by (1) an ear-worn sensing device, (2) a device in communication with the ear-worn sensing device, (3) by multiple devices in communication with the ear-worn sensing device, or (4) by cooperation of the ear-worn sensing device and one or more other devices. Many configurations are possible. For simplicity of description and illustration, the embodiments that follow relate to an example configuration in which an ear-worn sensing device is configured to cooperatively execute the signal processing pipeline 500 with at least one other electronic device. For example, an example ear-worn sensing device may be communicably coupled to a cellular phone.

The signal processing pipeline 500 includes a first stage 502 at which an ear-worn sensing device (and/or a pair of ear-worn sensing devices, one worn in each ear by a user) is configured to poll or otherwise sample one or more sensors to collect contextual information in respect of position or motion of one or more anatomical features of the wearer, or other biomechanical phenomena (or indeed any occurrence resulting from nonvocalized speech and detectable by the sensing system). For example, as described herein, the sensors may include motion, deformation, vibration, and pressure sensor systems, and at the first stage 502, the ear-worn sensing device may poll or otherwise sample these sensors to collect information relating to motion, shape changes, air pressure, and/or vibrations detected by the sensing systems. Further, the ear-worn sensing device can be configured to determine or infer a position or motion of the wearer’s TMJ. In other embodiments, the ear-worn sensing device can be configured to infer whether the wearer has constricted or relaxed one or more muscles (e.g., facial muscles, neck muscles, and the like). In other embodiments, the ear-worn sensing device can be configured to infer whether a user has swallowed or has engaged the tensor veli palatini, the levator veli palatini, and/or salpingopharyngeus. In yet other examples, the ear-worn sensing device can be configured to determine whether the user has gestured with their head, such as by nodding, shaking, or otherwise moving. In yet other examples, the ear-worn sensing device can be configured to determine whether vibration is present or absent, whether deformation of the ear canal is detected, or the like.

More broadly, at the first stage 502, the signal processing pipeline 500 can be configured to sample an arbitrary number of sensors to infer an arbitrary quantity of biomechanical data or, more specifically, any information in respect of one or more biomechanical or biological states, anatomical positions, muscle engagements, muscle relaxations, vibrations, sounds, pressures, temperatures, myoelectric activity, and the like.

Example sensors that may be leveraged by an ear-worn sensing device as described herein include but are not limited to: inertial measurement units (IMUs), such as accelerometers, gyroscopes, and magnetometers, which may be used individually or in combination to detect movement, orientation, or tremors of the head or jaw; strain gauges configured, positioned and oriented to detect deformations in a housing of the ear-worn device or the ear canal itself; microphones (e.g., contact microphones or bone conduction microphones) for detecting vocalizations, internal body sounds (such as chewing, swallowing, or speaking), or environmental audio; electromyography sensors with electrodes disposed to contact the wearer’s skin such as the skin surface of the inner ear to measure myoelectric activity of facial or neck muscles; proximity sensors (e.g., infrared, VCSEL-based sensors, ultrasonic sensors) to detect deformation or motion within the ear canal or surrounding tissue; optical sensors such as photoplethysmography sensors to detect local blood volume changes for heart rate or oxygen saturation; colorimeters to detect changes in local blood volume or pressure; thermistors or other thermal sensors to detect local skin temperature or changes due to blood flow or airflow; capacitive or resistive sensors for detecting contact, skin impedance, or hydration levels; air pressure sensors to detect changes in air pressure and/or sealed volumes within the ear canal; and acoustic sensors configured for otoacoustic emission analysis or tympanic membrane vibration detection. In yet other embodiments, an ear-worn sensing device may include piezoelectric sensors to detect mechanical pressure or vibrations, ultrasonic transducers for echo-based detection of anatomical movement or fluid levels, and ambient light sensors to adjust processing based on lighting context or detect light-based signals through the ear canal.

Any of the foregoing sensors and/or other sensors or sensing systems that can be leveraged by an ear-worn sensing device as described herein may be configured to conductively couple to one or more processors or sub-processors of the ear-worn sensing device. For example, a processor of the ear-worn sensing device can be conductively coupled to a first sensor that is configured to periodically report a current state of the sensor. In this configuration, the first sensor and the processor may be coupled in an interrupt configuration such that subroutines of the processor are interrupted in response to each report from the first sensor. In other examples, the processor can be configured to conductively couple to a second sensor configured to provide a continuous output (e.g., pulse-width modulated output, analog output, variable frequency output, digital serial output, or the like). In this example, the processor can be configured to execute a routine to sample an output of the second sensor at an interval or in response to an instruction. In some cases, an analog sensor can be provided as input to an analog to digital converter that, in turn, is communicably coupled to the processor and/or a memory of the ear-worn sensing device. More generally, in view of the foregoing, it may be appreciated that a processor as described herein can be suitably coupled to any number of sensors in any suitable way.

In certain embodiments, the ear-worn sensing device may implement sensor fusion techniques—and/or other methods to combine information from multiple sensors—to improve the accuracy, reliability, and contextual relevance of the information inferred at the first stage 502 of the signal processing pipeline 500. Sensor fusion as used herein may refer generally to a process of combining data from multiple different types or instances of sensors to account for error, improve precision or accuracy, or otherwise to provide more accurate or meaningful inferences than that which may be obtained from any individual sensor alone. As may be appreciated, sensor fusion techniques can be leveraged to compensate for sensing range limitations, noise, drift, or other error in any one data stream by leveraging the complementary strengths of multiple sensing instances and/or modalities.

For example, data from an inertial measurement unit may be fused with data from strain gauges and electromyography sensors to distinguish between head movements caused by intentional gestures (e.g., nodding) and those caused by jaw activity (e.g., chewing, swallowing, or speaking). Similarly, data from microphones configured to detect internal sounds (e.g., via bone conduction, otoacoustic sounds, and the like) may be fused with proximity or pressure or deformation sensor data, such as a pressure sensor oriented to determine pressure within the ear canal, to confirm the occurrence of a swallow, distinguish it from speech, or assess the amplitude and frequency characteristics of temporomandibular joint movement.

As with other embodiments described herein, in some embodiments, sensor fusion can be implemented and/or performed in whole or in part locally on the ear-worn device itself using embedded processing hardware, such as a microcontroller or digital signal processor. In other embodiments, raw or pre-processed data from multiple sensors can be streamed to a secondary processing device—such as a smartphone, smartwatch, or edge computing device—which may be configured to perform more computationally demanding tasks such as machine inference, filtering, clipping correction, estimation via Kalman filtering, or real-time decision trees. The division of processing between devices may be configurable based on available processing resources, battery life, latency, or user preference.

Further to the foregoing, regardless of whether a given sensor or set of sensors are fused, it may be appreciated that output of the first stage 502 may be one or more digital values that may be processed in software executing on the ear-worn sensing device or a device coupled thereto. A digital signal and/or digital values (e.g., a stream of digital values, each corresponding to a particular data source or fusion source) may be provided as output. More generally, output of the first stage 502 may be a data structure, memory location, or stream of digital values.

The output of the first stage 502 may be received at the second stage 504 which may be configured for processing sensor outputs, fused sensor streams, or combinations thereof. The second stage 504 may be configured for conditioning signals output from the first stage 502 and/or extracting one or more features from one or more signals output from the first stage 502, and/or tagging or labeling one or more features of the signals output by the first stage 502.

More particularly, the second stage 504 of the signal processing pipeline 500 may be generally and broadly suited to processes of cleaning, normalizing, or transforming raw or fused sensor signals into forms more suitable for further processing. This may include operations such as filtering (e.g., low-pass, high-pass, band-pass, or notch filtering), baseline drift removal, artifact suppression (e.g., motion or electrical noise artifacts), artifact amplification, gain normalization, resampling (e.g., up-sampling or down-sampling), synchronization of signals across sensor types, associating signal samples to timestamps, packaging multiple sensors into event or timeseries data objects, domain conversion (e.g., frequency domain conversion, discrete conversion), and the like. Such conditioning operations can reduce noise, drift, or other transient inconsistencies or inaccuracies in raw sensor and fusion signals in order to ensure that downstream processing operations are not influenced thereby. These operations may be generally referred to herein as “conditioning” operations.

Once one or more input signals are conditioned, feature extraction operations may be performed to convert the stream/continuous signal data into discrete, numerical features or labeled events that can be analyzed by downstream classifiers, state machines, or inference engines. Features may be extracted in the time domain, discrete domain, frequency domain, or a combination thereof. For example, time-domain features may include signal amplitude, root-mean-square energy, zero-crossing rate, signal envelope, autocorrelation metrics, or waveform shape descriptors (e.g., noun labels of waveform shapes or portions of waveforms). Frequency-domain features may include dominant frequency components, spectral centroid, bandwidth, and/or harmonic structure.

In some embodiments, combinations of time-domain and frequency-domain features from multiple sensors (e.g., gyroscope and microphone data) may be extracted to detect or infer motion, anatomical positions or shapes, muscular states, or the like, with labels being applied to the combined signals that correspond to anatomical inferences.

For instance, a jaw opening movement may be inferred and labeled on receiving and/or sampling a pattern of upward accelerometer movement combined with a bone conduction signal from a microphone registering a pop or click of the TMJ. In other cases, subtle features indicative of tongue movement may be inferred from transient shifts in proximity sensor data near the inner ear sidewalls, when sensed close in time to otoacoustic sounds or pressure changes or myoelectric signals sampled from nearby muscle structure.

As noted above, an ear-worn sensing device can be configured to detect whether a wearer is mouthing words or pantomiming speech, by, for example, a combination of temporal features of one or more signals and multi-sensor correlation analysis.

In many embodiments, features extracted from one or more signals can be captured as a vector data structure in which entries correspond to different sensor activations, quantization, threshold satisfaction, or the like. In some cases, feature vectors generated from extracted features may be provided as input to a machine-learning model trained to classify various anatomical positions and configurations (and transitions therebetween of sequences thereof) or user behaviors.

More specifically, output of normalization/conditioning/feature extraction operations of the second stage 504 can be provided as input to a tokenization or classification stage, identified as the third stage 506. At the third stage 506, feature-tagged raw sensor output may be provided as input to one or more neural networks, labelers, classifiers, or other machine learning system trained to correlate sensor outputs to parts of speech, such as phonemes or words. For example, a machine learning model implemented and/or instantiated at the third stage 506 may be configured to receive, as input, inertial measurement unit data, deformation data, vibration data, accelerometer data, temperature data, blood colorimeter data, microphone data, bone condition data, pressure data, and/or myoelectric data and to provide, as output, activation of one of a set of phonemes for a given language.

For example, in English, forty four possible phonemes may be articulated by a speaker. In this example, the machine learning model can be configured to provide as output a vector with forty four entries, each of which contains a value corresponding to an activation of a particular associated English-language phoneme. For example, if the wearer performs the requisite anatomical motion to make an “O” sound (e.g., particular position of the tongue, lips, jaw, and the like), the machine learning model may be configured to provide a strong activation of a vector entry corresponding to the “O” phoneme. In this manner, the model may, at the third stage 506, provide as output a series of predicted phonemes in a given language or in one of a set of languages. In some embodiments, the third stage 506 can be further configured and/or separately configured to classify words. In some cases, the third stage 506 can classify sensor input as words or, in other cases, the third stage 506 can be configured to classify sequences of phonemes as words or sets of likely words, in one or more languages.

A machine learning model may be trained on training data including sample sensor information (and/or sample motion information) generated by the sensing system in response to nonvocalized expressions, by the user, of a set of training words. For example, one or more users may nonvocally express a set of training or sample words, phonemes, or other expressions while wearing one or more ear-worn sensing devices. A machine learning model may be trained using this data set, such that the machine learning model can select a candidate word, phoneme, or other expression from an input from a sensing system of an ear-worn sensing device. In some cases, a machine learning model (or any other model or aspect of the processing pipeline described herein) may be tuned for a particular user. For example, a user may nonvocally express a set of training words (or phonemes) while wearing one or more ear-worn sensing devices, and the ear-worn sensing devices (and/or other associated electronic devices) may tune, modify, or otherwise adapt an aspect of the processing pipeline based on information captured by the various sensing systems during the nonvocalized expression.

Thereafter, at the fourth stage 508, words or phonemes (or both) (and/or sequences thereof) can be received as streamed digital input to be further processed, displayed, characterized, tagged, or used as input to a generative output system or agentic system to perform other actions, tasks, or work items.

In some embodiments, the fourth stage 508 may be implemented as a contextual interpretation or application layer that receives symbolically meaningful outputs from the third stage 506 and associates the received words or phonemes (and/or patterns therein or sequences thereof) with higher-level constructs, user intents, words, or commands. For example, if a sequence of phonemes is classified into a spoken command such as “call XYZ,” the fourth stage 508 may interpret the detected sequence as a device-level instruction to initiate a phone call.

For example, in some embodiments, the fourth stage 508 may include natural language processing modules configured to parse grammatical structure (in one or more languages), perform named entity recognition, resolve ambiguities (e.g., pronoun resolution), or derive semantic intent from input sequences. Such operations can be performed by and/or with one or more large language models or generative output engines prompted to extract user intents from structured data including the plain text or phoneme output from the third stage 506. In other embodiments, an ear-worn sensing device as described herein may incorporate dialog state tracking to maintain context across multiple user interactions or pantomimed words.

As noted above, in other embodiments, the fourth stage 508 may be integrated with generative models or agentic systems capable of producing multimodal outputs or triggering sequences of actions based on inferred user goals. This may include initiating tasks such as composing messages, updating schedules, querying databases, generating documents, retrieving media, or navigating user interfaces via multimodal or voice-based interactions. In some embodiments, the fourth stage 508 may support real-time output via a display such as closed captioning, real-time speech-to-text transcription, language translation, or the like.

FIG. 6 depicts an example schematic diagram of an electronic device 600. The electronic device 600 may be an embodiment of or otherwise represent any electronic device described herein, including any wearable nonvocalized speech detection system and/or ear-worn sensing device described herein (e.g., the ear-worn sensing device 101, 201, the wearable nonvocalized speech detection system 400, etc.), remote devices (e.g., devices that are communicatively coupled to ear-worn sensing devices), augmented- or virtual-reality devices associated with ear-worn sensing devices, mobile phones communicatively coupled to ear-worn sensing devices, supplemental processing devices (e.g., base units), or the like. The device 600 includes one or more processing units 601 that are configured to access a memory 602 having instructions stored thereon. The instructions or computer programs may be configured to perform one or more of the operations or functions described with respect to the electronic devices described herein. For example, the instructions may be configured to control or coordinate the operation of one or more displays 608, one or more touch sensors 603, one or more force sensors 605, one or more image capture systems 614, one or more communication systems 604, one or more audio input systems 609, one or more audio output systems 610, one or more positioning systems 611, one or more sensors 612, and/or one or more haptic feedback devices 606.

The processing units 601 of FIG. 6 may be implemented as any electronic component capable of processing, receiving, or transmitting data or instructions. For example, the processing units 601 may include one or more of: a microprocessor; a central processing unit (CPU); an application-specific integrated circuit (ASIC); a digital signal processor (DSP); or combinations of such devices. As described herein, the term “processor” is meant to encompass a single processor or processing unit, multiple processors, multiple processing units, or other suitably configured computing element or elements. The processing units 601 may be coupled to a circuit board assembly.

The memory 602 can store electronic data that can be used by the device 600. For example, a memory can store electrical data or content such as, for example, audio and video files, images, documents and applications, device settings and user preferences, programs, instructions, timing and control signals or data for the various modules, data structures or databases, and so on. The memory 602 can be configured as any type of memory. By way of example only, the memory can be implemented as random access memory, read-only memory, Flash memory, removable memory, or other types of storage elements, or combinations of such devices. The memory 602 may be coupled to a circuit board assembly.

The touch sensors 603 may detect various types of touch-based inputs and generate signals or data that are able to be accessed using processor instructions. The touch sensors 603 may use any suitable components and may rely on any suitable phenomena to detect physical inputs (e.g., touch inputs, haptic inputs). For example, the touch sensors 603 may be capacitive touch sensors, resistive touch sensors, acoustic wave sensors, or the like. The touch sensors 603 may include any suitable components for detecting touch-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The touch sensors 603 may be integrated with or otherwise configured to detect touch inputs applied to any portion of the device 600. For example, the touch sensors 603 may be configured to detect touch inputs applied to any portion of the device 600, including a device housing and/or exterior surfaces, a display, a device body, etc. A touch sensor may also or instead be integrated with a display. The touch sensors 603 may operate in conjunction with the force sensors 605 to generate signals or data in response to touch inputs. A touch sensor or force sensor that is positioned over a display surface or otherwise integrated with a display may be referred to herein as a touch-sensitive display, force-sensitive display, touchscreen display, or touchscreen.

The force sensors 605 may detect various types of force-based inputs and generate signals or data that are able to be accessed using processor instructions. The force sensors 605 may use any suitable components and may rely on any suitable phenomena to detect physical inputs. For example, the force sensors 605 may be strain-based sensors, piezoelectric-based sensors, piezoresistive-based sensors, capacitive sensors, resistive sensors, or the like. The force sensors 605 may include any suitable components for detecting force-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The force sensors 605 may be used in conjunction with various input mechanisms to detect various types of inputs. For example, the force sensors 605 may be used to detect presses or other force inputs that satisfy a force threshold (which may represent a more forceful input than is typical for a standard “touch” input). Like the touch sensors 603, the force sensors 605 may be integrated with or otherwise configured to detect force inputs applied to any portion of the device 600. For example, the force sensors 605 may be configured to detect force inputs applied to any portion of the device 600 that includes a display (and may be integrated with a display). The force sensors 605 may operate in conjunction with the touch sensors 603 to generate signals or data in response to touch- and/or force-based inputs.

The device 600 may also include one or more haptic devices 606. The haptic device 606 may include one or more of a variety of haptic technologies such as, but not limited to, rotational haptic devices, linear actuators, piezoelectric devices, vibration elements, and so on. In general, the haptic device 606 may be configured to provide punctuated and distinct feedback to a user of the device. More particularly, the haptic device 606 may be adapted to produce a knock or tap sensation and/or a vibration sensation. Such haptic outputs may be provided in response to detection of touch and/or force inputs, and may be imparted to a user through the exterior surface of the device 600 (e.g., via a surface that acts as a touch- and/or force-sensitive display or surface), or via a surface that is in contact with the user’s skin (e.g., in an ear canal).

The one or more communication systems 604 may include one or more wired or wireless interface(s) (e.g., wired or wireless communication systems) that are adapted to provide communication between the processing unit(s) 601 (or any other systems or components of the device 600) and an external device. The one or more communication systems 604 may include antennas (e.g., antennas that include or use housing components as radiating members), communications circuitry, firmware, software, or any other components or systems that facilitate wireless communications with other devices. In general, the one or more communication systems 604 may be configured to transmit and receive data and/or signals that may be interpreted by instructions executed on the processing units 601. In some cases, the external device is part of an external communication network that is configured to exchange data with wireless devices. Generally, the wireless interface may communicate via, without limitation, radio frequency, optical, acoustic, and/or magnetic signals and may be configured to operate over a wireless interface or protocol. Example wireless interfaces include radio frequency cellular interfaces (e.g., 2G, 3G, 4G, 4G long-term evolution (LTE), 5G, GSM, CDMA, or the like), fiber optic interfaces, acoustic interfaces, Bluetooth interfaces, infrared interfaces, USB interfaces, Wi-Fi interfaces (e.g., for communicating using Wi-Fi communication standards and/or protocols, including IEEE 802.11, 802.11b, 802.11a, 802.11g, 802.11n, 802.11ac, 802.11ax (Wi-Fi 6, 6E), 802.11be (Wi-Fi 7), or any other suitable Wi-Fi standards and/or protocols), TCP/IP interfaces, network communications interfaces, or any conventional communication interfaces. The one or more communication systems 604 may also include ultra-wideband (UWB) interfaces, which may include any appropriate communications circuitry, instructions, and number and position of suitable UWB antennas.

As shown in FIG. 6, the device 600 may include a battery 607 that is used to store and provide power to the other components of the device 600. The battery 607 may be a rechargeable power supply that is configured to provide power to the device 600. The battery 607 may be coupled to charging systems (e.g., wired and/or wireless charging systems) and/or other circuitry to control the electrical power provided to the battery 607 and to control the electrical power provided from the battery 607 to the device 600.

The device 600 may also include one or more displays 608 configured to display graphical outputs. The displays 608 may use any suitable display technology, including liquid crystal displays (LCD), organic light-emitting diodes (OLED), active-matrix organic light-emitting-diode displays (AMOLED), or the like. The displays may use a low temperature polycrystalline silicone (LTPS) or low temperature polycrystalline oxide (LTPO) backplane. The displays 608 may display graphical user interfaces, images, icons, or any other suitable graphical outputs. The displays 608 may convey information about the attention state of an emotive companion, the mode of operation of an emotive companion, or other information.

The device 600 may also provide audio input functionality via one or more audio input systems 609. The audio input systems 609 may include microphones, transducers, or other devices that capture sound for voice calls, video calls, audio recordings, video recordings, voice commands, and the like.

The device 600 may also provide audio output functionality via one or more audio output systems (e.g., speakers) 610, such as the speaker systems and/or modules described herein. The audio output systems 610 may produce sound from voice calls, video calls, text-to-speech modules, streaming or local audio content, streaming or local video content, or the like. The audio output systems 610 may produce sound from text (e.g., via a text-to-speech system) that was generated from another ear-worn sensing device from nonvocalized speech.

The device 600 may also include a positioning system 611. The positioning system 611 may be configured to determine the location of the device 600. For example, the positioning system 611 may include magnetometers, gyroscopes, accelerometers, optical sensors, cameras, global positioning system (GPS) receivers, inertial positioning systems, or the like. The positioning system 611 may be used to determine spatial parameters of the device 600, such as the location of the device 600 (e.g., geographical coordinates of the device), measurements or estimates of physical movement of the device 600, an orientation of the device 600, or the like. The positioning system may provide motion sensing functions of a wearable nonvocalized speech detection system (e.g., an ear-worn device), or the motion sensing functions may be provided by a separate system that is dedicated to detecting motion corresponding to nonvocalized speech.

The device 600 may also include one or more additional sensors 612 (also referred to as sensing systems) to receive inputs (e.g., from a user or another computer, device, system, network, etc.) or to detect any suitable property or parameter of the device, the environment surrounding the device, people, or things interacting with the device (or nearby the device), or the like. For example, a device may include temperature sensors, biometric sensing systems (e.g., fingerprint sensors, facial recognition systems, photoplethysmographs, blood-oxygen sensors, blood sugar sensors, or the like), eye-tracking sensors, proximity sensors, depth sensors (e.g., time-of-flight based depth or distance sensors), ambient light sensors, retinal scanners, humidity sensors, buttons, switches, lid-closure sensors, or the like. The additional sensors 612 may include a motion sensing system 408, deformation sensing system 410, and/or vibration sensing system 412, as described, for example, with respect to FIG. 4.

The device 600 may also include one or more image capture systems 614. The image capture system 614, along with the audio input system 609 and optionally other systems, may be part of an overall input system of the device 600. The image capture system 614 may include one or more cameras, and may be configured to capture images (e.g., still and/or video images). Captured images may be stored as displayable image files, and/or used as inputs to the device 600 for other operations. The image capture system 614 may include an imaging sensor, an image processor, a lens, and other components to facilitate the image capture operations of the image capture system 614.

To the extent that multiple functionalities, operations, and structures described with reference to FIG. 6 are disclosed as being part of, incorporated into, or performed by the device 600, it should be understood that various embodiments may omit any or all such described functionalities, operations, and structures. Thus, different embodiments of the device 600 may have some, none, or all of the various capabilities, apparatuses, physical features, modes, and operating parameters discussed herein. Further, the systems included in the device 600 are not exclusive, and the device 600 may include alternative or additional systems, components, modules, programs, instructions, or the like, that may be necessary or useful to perform the functions described herein.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A wearable nonvocalized speech detection system comprising:
a body configured to be positioned at least partially in an ear canal of a user;
a sensing system positioned in the body and configured to:
detect motion of the ear canal resulting from articulation of a mouth of the user corresponding to a nonvocalized expression of one or more words; and
generate motion information representative of the detected motion; and
a processing system operatively coupled to the sensing system and configured to generate, based on the motion information, a representation of the one or more words.

2. The wearable nonvocalized speech detection system of claim 1, wherein the sensing system comprises an accelerometer.

3. The wearable nonvocalized speech detection system of claim 1, wherein the sensing system comprises an inertial measurement unit.

4. The wearable nonvocalized speech detection system of claim 1, wherein:
the wearable nonvocalized speech detection system further comprises a compliant structure coupled to the body and configured to contact a surface of the ear canal;
the sensing system further includes a sensing element coupled to the compliant structure;
the sensing system is further configured to:
detect, via the sensing element, a change in shape of the surface of the ear canal resulting from the articulation of the user’s mouth corresponding to the nonvocalized expression of the one or more words; and
generate deformation information representative of the detected change in shape of the surface of the ear canal; and
the processing system is further configured to generate the representation of the one or more words further based on the deformation information.

5. The wearable nonvocalized speech detection system of claim 4, wherein the sensing element includes a strain gauge.

6. The wearable nonvocalized speech detection system of claim 1, wherein the motion of the ear canal occurs as a result of movement of a temporomandibular joint during the nonvocalized expression of the one or more words.

7. The wearable nonvocalized speech detection system of claim 1, further comprising a wireless communication system operatively coupled to the processing system and configured to send the representation of the one or more words to a remote device.

8. The wearable nonvocalized speech detection system of claim 7, wherein the remote device is configured to generate an audio output of the one or more words in response to receiving the representation of the one or more words.

9. The wearable nonvocalized speech detection system of claim 1, wherein the processing system is configured to execute a machine learning model to generate the representation of the one or more words, the machine learning model trained on training data including sample motion information generated by the sensing system in response to nonvocalized expressions by the user of a set of training words.

10. A wearable nonvocalized speech detection system comprising:
a body configured to be positioned at least partially in an ear canal of a user;
a compliant structure coupled to the body and configured to contact a surface of the ear canal;
a sensing system comprising a sensing element coupled to the compliant structure, the sensing system configured to:
detect, via the sensing element, a change in shape of the surface of the ear canal resulting from articulation of a mouth of the user corresponding to a nonvocalized expression of one or more words; and
generate deformation information representative of the detected change in shape of the surface of the ear canal; and
a processing system operatively coupled to the sensing system and configured to generate, based on the deformation information, a representation of the one or more words.

11. The wearable nonvocalized speech detection system of claim 10, wherein the sensing element is a strain gauge.

12. The wearable nonvocalized speech detection system of claim 11, wherein the sensing element is at least partially embedded in the compliant structure.

13. The wearable nonvocalized speech detection system of claim 10, wherein the compliant structure comprises a flexible polymer.

14. The wearable nonvocalized speech detection system of claim 10, wherein:
the sensing system further includes a motion sensing system;
the sensing system is further configured to:
detect, via the motion sensing system, motion of the ear canal resulting from the articulation of the user’s mouth corresponding to the nonvocalized expression of the one or more words; and
generate motion information representative of the detected motion; and
the processing system is further configured to generate the representation of the one or more words further based on the motion information.

15. The wearable nonvocalized speech detection system of claim 10, wherein the change in shape of the surface of the ear canal occurs as a result of movement of a temporomandibular joint during the nonvocalized expression of the one or more words.

16. The wearable nonvocalized speech detection system of claim 10, wherein the processing system is configured to execute a machine learning model to generate the representation of the one or more words, the machine learning model trained on training data including sample deformation information generated by the sensing system in response to nonvocalized expressions by the user of a set of training words.

17. The wearable nonvocalized speech detection system of claim 10, further comprising a wireless communication system operatively coupled to the processing system and configured to send the representation of the one or more words to a remote device.

18. The wearable nonvocalized speech detection system of claim 10, further comprising a microphone configured to detect vibrations resulting from phonated speech.

19. The wearable nonvocalized speech detection system of claim 18, wherein the microphone is a bone conduction microphone.

20. The wearable nonvocalized speech detection system of claim 18, wherein the phonated speech is below about 30 dB.
